(19) United States
(12) Patent Application Publication
(10) Pub. No.: US 2025/0218224 A1
(43) Pub. Date: Jul. 3, 2025

(54) METHOD FOR RECOGNIZING GESTURE, ELECTRONIC DEVICE AND STORAGE MEDIUM

(71) Applicant: Beijing Zitiao Network Technology Co., Ltd., Beijing (CN)

(72) Inventors: Hui HU, Beijing (CN); Kaixuan FAN, Beijing (CN); Zeming LI, Beijing (CN)

(21) Appl. No.: 18/988,702

(22) Filed: Dec. 19, 2024

(30) Foreign Application Priority Data
Dec. 28, 2023 (CN) 202311841364.8

(51) Int. Cl. G06V 40/20; G06T 7/73; G06V 10/77

(52) U.S. Cl. CPC G06V 40/28; G06T 7/73; G06V 10/7715; G06T 2207/30196

(57) ABSTRACT

Embodiments of the present disclosure provide a method for recognizing a gesture, a device, and a storage medium; and the method includes: acquiring a plurality of frames of images including a hand object within a first preset duration before a current time; respectively performing feature extraction on the plurality of frames of images to obtain a feature vector corresponding to each of the plurality of frames of images; determining at least one frame of target image before the current frame of image, and determining pose information corresponding to the hand object according to a feature vector corresponding to the current frame of image, a feature vector corresponding to each frame of target image and a preset deep learning model; and determining gesture command information corresponding to the hand object according to the feature vector corresponding to each of the frames of images and the preset deep learning model.

### CROSS-REFERENCE TO RELATED APPLICATION

The present application claims the priority to Chinese Patent Application No. 202311841364.8, filed on Dec. 28, 2023, the entire disclosure of which is incorporated herein by reference as portion of the present application.

### TECHNICAL FIELD

Embodiments of the present disclosure relate to a method and an apparatus for recognizing a gesture, an electronic device, and a storage medium.

### BACKGROUND

With the development of image processing technology, technicians have developed more and more image processing scenarios, such as virtual reality scenarios, augmented reality scenarios, and the like. In many interactive scenarios, it is necessary to recognize a gesture of a hand object to obtain an operation command corresponding to the gesture.

### SUMMARY

Embodiments of the present disclosure provide a method and an apparatus for recognizing a gesture, an electronic device, and a storage medium.

In a first aspect, the embodiments of the present disclosure provide a method for recognizing a gesture, the gesture includes pose information and gesture command information, and the method includes:
acquiring a plurality of frames of images including a hand object within a first preset duration before a current time;
respectively performing feature extraction on the plurality of frames of images to obtain a feature vector corresponding to each of the plurality of frames of images;
for a current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and
determining gesture command information corresponding to the hand object according to the feature vector corresponding to each of the plurality of frames of images and the preset deep learning model.

In a second aspect, the embodiments of the present disclosure provide an apparatus for recognizing a gesture, the gesture includes pose information and gesture command information, and the apparatus includes:
an acquisition module which is configured to acquire a plurality of frames of images including a hand object within a first preset duration before a current time;
a feature extraction module which is configured to respectively perform feature extraction on the plurality of frames of images to obtain a feature vector corresponding to each of the plurality of frames of images;
a first recognition module which is configured to, for a current frame of image, determine at least one frame of target image before the current frame of image, and determine pose information corresponding to the hand object according to a feature vector corresponding to the current frame of image, a feature vector corresponding to each of the at least one frame of target image and a preset deep learning model; and
a second recognition module which is configured to determine gesture command information corresponding to the hand object according to the feature vector corresponding to each of the plurality of frames of images and the preset deep learning model.

In a third aspect, the embodiments of the present disclosure provide an electronic device, including:
a processor and a memory which is in communication connection with the processor;
the memory is configured to store computer-executable instructions; and
the processor is configured to execute the computer-executable instructions stored in the memory to implement the method for recognizing a gesture according to the above-mentioned first aspect or various possible embodiments of the first aspect.

In a fourth aspect, the embodiments of the present disclosure provide a non-transitory computer-readable storage medium, which stores computer-executable instructions, and a processor, when executing the computer-executable instructions, implements a method for recognizing a gesture according to the above-mentioned first aspect or various possible embodiments of the first aspect.

In a fifth aspect, the embodiments of the present disclosure provide a computer program product, which includes a computer program, and the computer program, when executed by a processor, implements a method for recognizing a gesture according to the above-mentioned first aspect or various possible embodiments of the first aspect.

### BRIEF DESCRIPTION OF DRAWINGS

In order to more clearly illustrate the technical solutions of the embodiments of the present disclosure, the drawings that need to be used in description of the embodiments will be briefly described in the following. Apparently, the drawings in the following description are only some embodiments of the present disclosure. For those ordinarily skilled in the art, other drawings can also be obtained based on these drawings without any inventive work.

FIG. 1 is a schematic diagram of an application scenario of a method for recognizing a gesture provided by the embodiment of the present disclosure;

FIG. 2 is a flowchart of a method for recognizing a gesture provided by the embodiments of the present disclosure;

FIG. 3 is a schematic diagram of a method for recognizing a gesture provided by the embodiments of the present disclosure;

FIG. 4 is a schematic diagram of another method for recognizing a gesture provided by the embodiments of the present disclosure;

FIG. 5 is a flowchart of a model training method provided by the embodiments of the present disclosure;

FIG. 6 is a structural block diagram of an apparatus for recognizing a gesture provided by the embodiments of the present disclosure; and

FIG. 7 is a schematic diagram of a hardware structure of an electronic device provided by the embodiments of the present disclosure.

### DETAILED DESCRIPTION

In order to make objects, technical solutions and advantages of the embodiments of the present disclosure apparent, the technical solutions of the embodiments of the present disclosure will be described in a clearly and fully understandable way in connection with the drawings related to the embodiments of the present disclosure. Apparently, the described embodiments are just a part but not all of the embodiments of the present disclosure. Based on the embodiments of the present disclosure, those ordinarily skilled in the art can obtain other embodiment(s), without any inventive work, which should be within the scope of the present disclosure.

It should be noted that user information (including but not limited to user device information, user personal information, etc.) and data (including but not limited to data used for analysis, stored data, displayed data, etc.) involved in the present disclosure are all information and data authorized by users or fully authorized by all parties, and it is needed to collect, use and process relevant data in accordance with relevant laws, regulations and standards of relevant countries and regions, and provide corresponding operation entrances for the users to choose to authorize or refuse.

With the development of image processing technology, technicians have developed more and more image processing scenarios, such as virtual reality scenarios, augmented reality scenarios, and the like. In many interactive scenarios, it is necessary to recognize a gesture of a hand object to obtain an operation command corresponding to the gesture.

For example, a method for recognizing a gesture includes: capturing a hand image at the current moment, and then inputting the hand image at the current moment into a trained neural network model to obtain a gesture recognition result corresponding to the hand image. However, the accuracy of gesture recognition on the hand image by using a single hand image at the current moment is relatively low. The neural network model may be a Convolutional Neural Networks (CNN) model.

In a Virtual Reality (VR) scenario, gesture recognition not only requires recognizing command gestures but also requires recognizing the pose information (3D pose) of each frame. In this case, a gesture includes both a gesture pose and a gesture command. In this case, it is necessary to deploy two models (a command gesture model and a pose prediction model) on an electronic device for recognition, which wastes the limited resources (memory, power consumption, computing power, and time consumption) of the electronic device. The electronic device may be a VR device, where resources of the VR device are even more limited, further highlighting the above-mentioned problems.

Thus, improving the recognition accuracy and recognition efficiency of gesture recognition is a technical problem that urgently needs to be solved.

To solve the above-mentioned problem, the embodiments of the present disclosure provide the following technical concept: integrating respective features of pose information and gesture command information, and recognizing the pose information and the gesture command information through images with different time sequences, respectively. The pose information changes variously in time sequence, the longer the time sequence, the more the combinations there are; and in response to the use of a very long time sequence input, it is difficult for the training data to cover all these combinations, which may cause over-fitting problems during training, so shorter sequences of data are used. On the other hand, there are not many pattern combinations of command gestures, so a longer time sequence can be inputted to make full use of the information on the time sequence to improve the accuracy of gesture recognition.

Correspondingly, specific steps may include: first, acquiring a plurality of frames of images including a hand object within a first preset duration before the current time; then respectively performing feature extraction on the plurality of frames of images to obtain a feature vector corresponding to each of the plurality of frames of images; then for the current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and finally, determining gesture command information corresponding to the hand object according to the feature vector corresponding to each of the plurality of frames of images and the preset deep learning model.

In this case, respective features of the pose information and the gesture command information are integrated, and the pose information and the gesture command information are respectively recognized through the images with different time sequences, so that the recognition accuracy is improved; and the pose information and the gesture command information can be obtained through the same model, so that the resource consumption of the electronic device is reduced, and the recognition efficiency is improved.

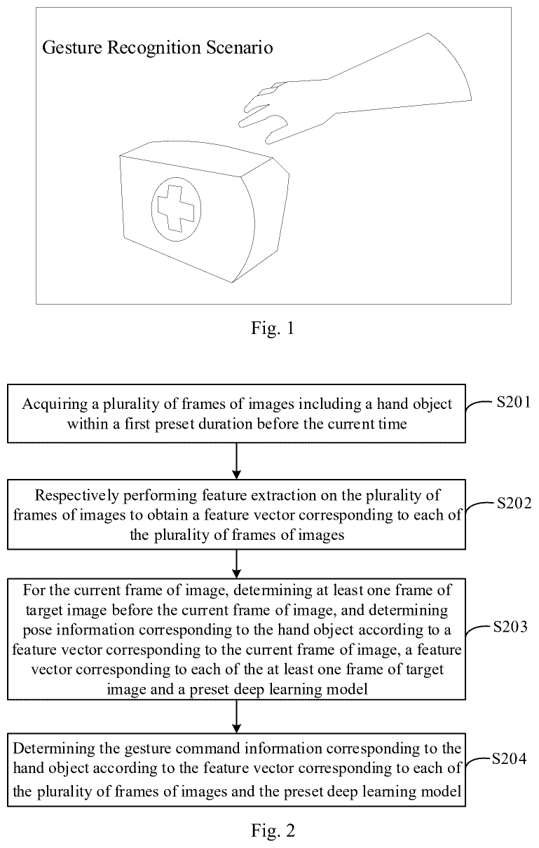

The application scenarios of the embodiments of the present disclosure are described as follows: the method for recognizing a gesture provided by the embodiments of the present disclosure may be applied to a plurality of scenarios. For example, the method may be applied to a VR game scenario. FIG. 1 is a schematic diagram of an application scenario of a method for recognizing a gesture provided by the embodiments of the present disclosure. Specifically, as shown in FIG. 1, a hand object is provided in FIG. 1, and the gesture pose and the gesture command of the hand object can be recognized through the method for recognizing a gesture provided by the embodiments of the present disclosure. The hand object is displayed in the VR game scenario according to the gesture pose. Moreover, according to the gesture command, an operation corresponding to the gesture command is determined (for example, take up a medical package, open the medical package, and the like). And finally, according to the operation corresponding to the gesture command, a corresponding operation is executed on the medical package (for example, open the medical package).

The method for recognizing a gesture provided by the embodiments of the present disclosure is detailed below with detailed embodiments.

FIG. 2 is a schematic flowchart of a method for recognizing a gesture provided by the embodiments of the present disclosure. The method may be applied to an electronic device, and the gesture includes pose information and gesture command information. Referring to FIG. 2, the method includes the following steps.

S201, acquiring a plurality of frames of images including a hand object within a first preset duration before the current time.

In this step, the numerical value of the first preset duration is not specifically limited. Optionally, the first preset duration is matched with the number of the plurality of frames of images including the hand object. Exemplarily, in response to that the number of the plurality of frames of images including the hand object is M, the first preset duration is the duration of capturing the M frames of images, where M is a positive integer.

S202, respectively performing feature extraction on the plurality of frames of images to obtain a feature vector corresponding to each of the plurality of frames of images.

In some embodiments, feature extraction may be performed on images by using an image feature extraction model. Correspondingly, this step includes: respectively performing feature extraction on the plurality of frames of images according to an image feature extraction model, to obtain the feature vector corresponding to each of the plurality of frames of images.

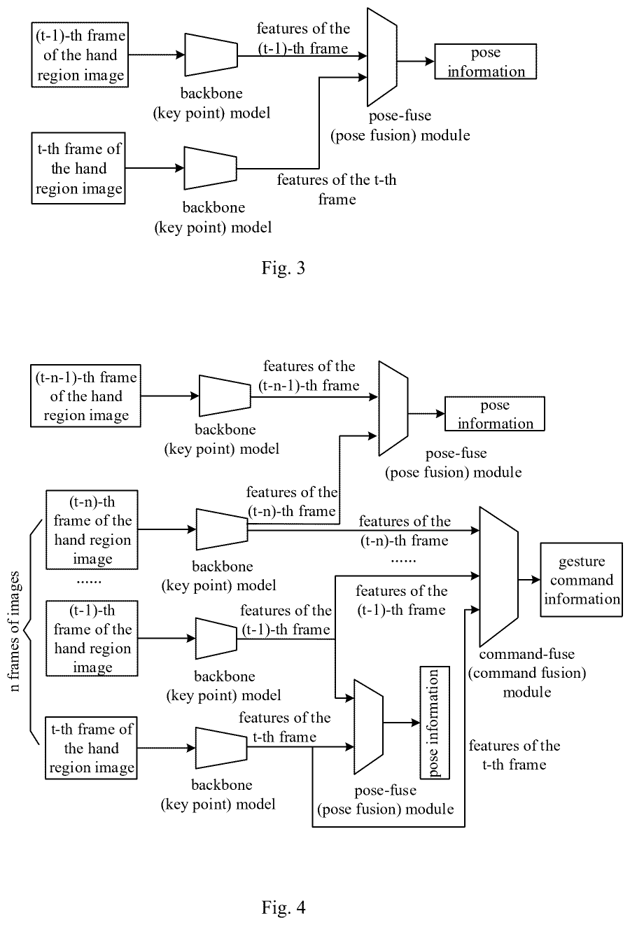

Exemplarily, as shown in FIG. 3, the image feature extraction model may be represented by a backbone (key point) model.

S203, for the current frame of image, determining at least one frame of target image before the current frame of image, and determining pose information corresponding to the hand object according to a feature vector corresponding to the current frame of image, a feature vector corresponding to each of the at least one frame of target image and a preset deep learning model.

In some embodiments, the preset deep learning model includes a pose fusion module; correspondingly, determining pose information corresponding to the hand object according to the feature vector corresponding to the current frame of image, the feature vector corresponding to each of the at least one frame of target image and the preset deep learning model, includes: determining the pose information corresponding to the hand object according to the feature vector corresponding to the current frame of image, the feature vector corresponding to each of the at least one frame of target image and the pose fusion module, in which the pose information includes coordinate information of a plurality of key points corresponding to the hand object and rotation angle information of each key point among the plurality of key points.

Exemplarily, as shown in FIG. 3, the pose fusion module may be represented by a “post-fuse module”.

In the embodiment of the present disclosure, the number of the at least one frame of target image is not specifically limited. The number may be 1, 2, 3 and the like.

Optionally, in response to that the pose information corresponding to the hand object is determined, the preset deep learning model may fuse the features of the current frame of image and the features of the at least one frame of target image before the current frame of image, thereby improving the accuracy of the obtained pose information.

In some embodiments, the number of the plurality of frames of images is M, and the current frame of image is the M-th frame of image, where M is a positive integer greater than 1; correspondingly, for the current frame of image, determining at least one frame of target image before the current frame of image includes: for the current frame of image, determining that previous N frames of image before the current frame of image are target images, where N is a positive integer, and M is greater than N.

Exemplarily, as shown in FIG. 3, M is t, and N is 1; and in response to that the current frame of image is the t-th frame of image, it is determined that the (t−1)-th frame of image is the target image. In this case, the pose fusion module (pose-fuse module) may fuse the feature vector corresponding to the t-th frame of image and the feature vector corresponding to the (t−1)-th frame of image to obtain the pose information corresponding to the hand object.

S204, determining the gesture command information corresponding to the hand object according to the feature vector corresponding to each of the plurality of frames of images and the preset deep learning model.

In some embodiments, the preset deep learning model further includes a command fusion module; correspondingly, this step may include: determining the gesture command information corresponding to the hand object according to feature vector corresponding to each of the plurality of frames of images and the command fusion module, in which the gesture command information includes a gesture command with an interactive function. Optionally, the gesture command information includes a click gesture, a grab gesture and the like.

As shown in FIG. 4, the command fusion module may be represented by a “command-fuse module”.

Optionally, by continuously referring to FIG. 4, the preset deep learning module may fuse the features extracted from the previous n frames of images, to predict the gesture command information of the current frame. For example, the plurality of frames include n frames, namely: the (t−n)-th frame of image, . . . , the (n−1)-th frame of image, and the n-th frame of image. In this case, the command fusion module (command-fuse module) may fuse the feature vector corresponding to the (t−n)-th frame of image, . . . , the feature vector corresponding to the (t−1)-th frame of image, and the feature vector corresponding to the t-th frame of image, to determine the gesture command information corresponding to the hand object.

The method for recognizing a gesture provided by the embodiments of the present disclosure includes: acquiring a plurality of frames of images including a hand object within a first preset duration before the current time; respectively performing feature extraction on the plurality of frames of images to obtain a feature vector corresponding to each of the plurality of frames of images; for the current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and determining gesture command information corresponding to the hand object according to the feature vector corresponding to each of the plurality of frames of images and the preset deep learning model.

In the embodiments of the present disclosure, the preset deep learning model includes the pose fusion module and the command fusion module. Considering the particularities inherent in the functionalities of recognizing pose information and gesture command information, a two-stage training method is designed. This approach can prevent the pose fusion module (pose-fuse module) from overfitting, while also enabling the command fusion module (command-fuse module) to access more comprehensive time sequence information for more accurate judgment.

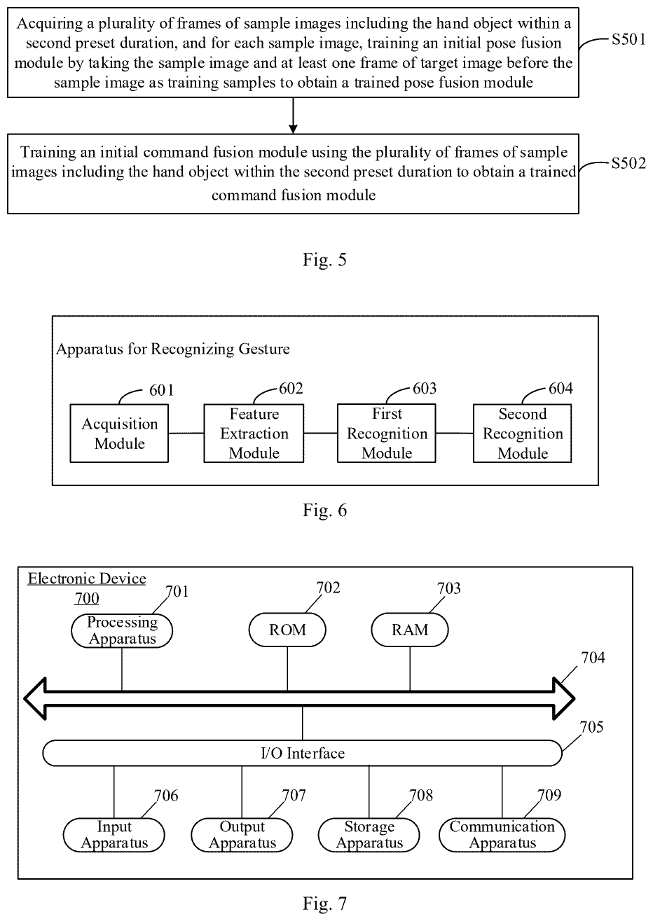

Correspondingly, as shown in FIG. 5, the training process of the preset deep learning model includes the following two stages.

First stage: S501, acquiring a plurality of frames of sample images including the hand object within a second preset duration, and for each sample image, training an initial pose fusion module by taking the sample image and at least one frame of target image before the sample image as training samples to obtain a trained pose fusion module.

Optionally, the input data includes the current frame of image and the previous frame of image. Feature extraction is performed on the current frame of image and the previous frame of image, respectively, to obtain two feature vectors; and the two feature vectors are taken as the training samples. In the present disclosure, the number of the training samples is not specifically limited. During the process of training the initial pose fusion module, the backstone (key point) module is also needed to be trained to ensure that the accuracy of the output feature vector reaches a preset value.

Second stage: S502, training an initial command fusion module using the plurality of frames of sample images including the hand object within the second preset duration to obtain a trained command fusion module.

In the present disclosure, the number of the plurality of frame sample images is not specifically limited. It should be noted that when the command fusion module is trained during the second stage, the backbone (key point) module and the pose fusion module (pose-fuse module) are finished in training, and parameters in the two models are kept fixed.

In the embodiments of the present disclosure, considering the particularities inherent in the functionalities of recognizing pose information and gesture command information, the two-stage training method is designed. This approach can prevent the pose fusion module (pose-fuse module) from overfitting, while also enabling the command fusion module (command-fuse module) to access more comprehensive time sequence information for more accurate judgment.

FIG. 6 is a structural block diagram of an apparatus for recognizing a gesture provided by the embodiments of the present disclosure, the gesture includes posture information and gesture command information and the apparatus includes: an acquisition module 601, a feature extraction module 602, a first recognition module 603 and a second recognition module 604.

The acquisition module 601 is configured to acquire a plurality of frames of images including a hand object within a first preset duration before the current time;
the feature extraction module 602 is configured to respectively perform feature extraction on the plurality of frames of images to obtain a feature vector corresponding to each of the plurality of frames of images;
the first recognition module 603 is configured to, for the current frame of image, determine at least one frame of target image before the current frame of image, and determine pose information corresponding to the hand object according to a feature vector corresponding to the current frame of image, a feature vector corresponding to each of the at least one frame of target image and a preset deep learning model; and
the second recognition module 604 is configured to determine gesture command information corresponding to the hand object according to the feature vector corresponding to each of the plurality of frames of images and the preset deep learning model.

According to one or more embodiments of the present disclosure, respectively performing, by the feature extraction module 602, feature extraction on the plurality of frames of images to obtain the feature vector corresponding to each of the plurality of frames of images, includes: respectively performing feature extraction on the plurality of frames of images according to an image feature extraction model, to obtain the feature vector corresponding to each of the plurality of frames of images.

According to one or more embodiments of the present disclosure, the preset deep learning model includes a pose fusion module; correspondingly, determining, by the first recognition module 603, the pose information corresponding to the hand object according to the feature vector corresponding to the current frame of image, the feature vector corresponding to each of the at least one frame of target image and the preset deep learning model, includes: determining the pose information corresponding to the hand object according to the feature vector corresponding to the current frame of image, the feature vector corresponding to each of the at least one frame of target image and the pose fusion module, in which the pose information includes coordinate information of a plurality of key points corresponding to the hand object, and rotation angle information of each key point among the plurality of key points.

According to one or more embodiments of the present disclosure, the preset deep learning model further includes a command fusion module; correspondingly, determining, by the second recognition module 604, the gesture command information corresponding to the hand object according to the feature vector corresponding to each of the plurality of frames of images and the preset deep learning model, includes: determining the gesture command information corresponding to the hand object according to the feature vector corresponding to each of the plurality of frames of images and the command fusion module, in which the gesture command information includes a gesture command with an interactive function.

According to one or more embodiments of the present disclosure, the number of the plurality of frames of images is M, and the current frame of image is the M-th frame of image, where M is a positive integer greater than 1; correspondingly, for the current frame of image, determining, by the first recognition module 603, at least one frame of target image before the current frame of image includes: for the current frame of image, determining that previous N frames of image before the current frame of image are target images, where N is a positive integer, and M is greater than N.

According to one or more embodiments of the present disclosure, the preset deep learning model includes a pose fusion module and a command fusion module; correspondingly, the apparatus further includes a training module; and the training process of training the preset deep learning module by the training module includes: a first stage: acquiring a plurality of frames of sample images including the hand object within a second preset duration, and for each sample image, training an initial pose fusion module by taking the sample image and at least one frame of target image before the sample image as training samples to obtain a trained pose fusion module; and a second stage: training an initial command fusion module using the plurality of frames of sample images comprising the hand object within the second preset duration to obtain a trained command fusion module.

The acquisition module 601, the feature extraction module 602, the first recognition module 603 and the second recognition module 604 are connected in sequence. The apparatus for recognizing a gesture provided by the embodiments of the present disclosure can perform the technical solutions of the above-mentioned method embodiments, and its implementation principle and technical effect are similar, which will not be repeated in the embodiment.

FIG. 7 is a schematic diagram of a hardware structure of an electronic device provided by the embodiments of the present disclosure. Referring to FIG. 7, the electronic device 700 may be a terminal device or a server. The terminal device may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 700 may include a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected through a bus 704. An input/output (I/O) interface 705 is also connected to the bus 704.

Usually, the following apparatuses may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 7 illustrates the electronic device 700 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the methods according to the above-mentioned embodiments.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, one or more embodiments of the present disclosure provide a method for recognizing a gesture, the gesture includes pose information and gesture command information, and the method includes:
acquiring a plurality of frames of images including a hand object within a first preset duration before a current time;
respectively performing feature extraction on the plurality of frames of images to obtain a feature vector corresponding to each of the plurality of frames of images;
for a current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and
determining gesture command information corresponding to the hand object according to the feature vector corresponding to each of the plurality of frames of images and the preset deep learning model.

According to one or more embodiments of the present disclosure, respectively performing feature extraction on the plurality of frames of images to obtain the feature vector corresponding to each of the plurality of frames of images, includes: respectively performing feature extraction on the plurality of frames of images according to an image feature extraction model, to obtain the feature vector corresponding to each of the plurality of frames of images.

According to one or more embodiments of the present disclosure, the preset deep learning model includes a pose fusion module; and determining the pose information corresponding to the hand object according to the feature vector corresponding to the current frame of image, the feature vector corresponding to each of the at least one frame of target image and the preset deep learning model, includes: determining the pose information corresponding to the hand object according to the feature vector corresponding to the current frame of image, the feature vector corresponding to each of the at least one frame of target image and the pose fusion module, in which the pose information includes coordinate information of a plurality of key points corresponding to the hand object, and rotation angle information of each key point among the plurality of key points.

According to one or more embodiments of the present disclosure, the preset deep learning model further includes a command fusion module; and determining the gesture command information corresponding to the hand object according to the feature vector corresponding to each of the plurality of frames of images and the preset deep learning model, includes: determining the gesture command information corresponding to the hand object according to the feature vector corresponding to each of the plurality of frames of images and the command fusion module, in which the gesture command information includes a gesture command with an interactive function.

According to one or more embodiments of the present disclosure, a total number of the plurality of frames of images is M, the current frame of image is an M-th frame of image, and M is a positive integer greater than 1; and for the current frame of image, determining at least one frame of target image before the current frame of image includes: for the current frame of image, determining that previous N frames of image before the current frame of image are target images, wherein N is a positive integer, and M is greater than N.

According to one or more embodiments of the present disclosure, the preset deep learning model includes a pose fusion module and a command fusion module; and a training process of the preset deep learning model includes: a first stage: acquiring a plurality of frames of sample images including the hand object within a second preset duration, and for each sample image, training an initial pose fusion module by taking the sample image and at least one frame of target image before the sample image as training samples to obtain a trained pose fusion module; and a second stage: training an initial command fusion module using the plurality of frames of sample images including the hand object within the second preset duration to obtain a trained command fusion module.

In a second aspect, one or more embodiments of the present disclosure provide an apparatus for recognizing a gesture, the gesture includes pose information and gesture command information, and the apparatus includes:
an acquisition module which is configured to acquire a plurality of frames of images including a hand object within a first preset duration before a current time;
a feature extraction module which is configured to respectively perform feature extraction on the plurality of frames of images to obtain a feature vector corresponding to each of the plurality of frames of images;
a first recognition module which is configured to, for a current frame of image, determine at least one frame of target image before the current frame of image, and determine pose information corresponding to the hand object according to a feature vector corresponding to the current frame of image, a feature vector corresponding to each of the at least one frame of target image and a preset deep learning model; and
a second recognition module which is configured to determine gesture command information corresponding to the hand object according to the feature vector corresponding to each of the plurality of frames of images and the preset deep learning model.

According to one or more embodiments of the present disclosure, respectively performing, by the feature extraction module, feature extraction on the plurality of frames of images to obtain the feature vector corresponding to each of the plurality of frames of images, includes: respectively performing feature extraction on the plurality of frames of images according to an image feature extraction model, to obtain the feature vector corresponding to each of the plurality of frames of images.

According to one or more embodiments of the present disclosure, the preset deep learning model includes a pose fusion module; correspondingly, determining, by the first recognition module, the pose information corresponding to the hand object according to the feature vector corresponding to the current frame of image, the feature vector corresponding to each of the at least one frame of target image and the preset deep learning model, includes: determining the pose information corresponding to the hand object according to the feature vector corresponding to the current frame of image, the feature vector corresponding to each of the at least one frame of target image and the pose fusion module, in which the pose information includes coordinate information of a plurality of key points corresponding to the hand object, and rotation angle information of each key point among the plurality of key points.

According to one or more embodiments of the present disclosure, the preset deep learning model further includes a command fusion module; correspondingly, determining, by the second recognition module, the gesture command information corresponding to the hand object according to the feature vector corresponding to each of the plurality of frames of images and the preset deep learning model, includes: determining the gesture command information corresponding to the hand object according to the feature vector corresponding to each of the plurality of frames of images and the command fusion module, in which the gesture command information includes a gesture command with an interactive function.

According to one or more embodiments of the present disclosure, the number of the plurality of frames of images is M, and the current frame of image is the M-th frame of image, where M is a positive integer greater than 1; correspondingly, for the current frame of image, determining, by the first recognition module, at least one frame of target image before the current frame of image includes: for the current frame of image, determining that previous N frames of image before the current frame of image are target images, where N is a positive integer, and M is greater than N.

According to one or more embodiments of the present disclosure, the preset deep learning model includes a pose fusion module and a command fusion module; correspondingly, the apparatus further includes a training module; and the training process of training the preset deep learning module by the training module includes: a first stage: acquiring a plurality of frames of sample images including the hand object within a second preset duration, and for each sample image, training an initial pose fusion module by taking the sample image and at least one frame of target image before the sample image as training samples to obtain a trained pose fusion module; and a second stage: training an initial command fusion module using the plurality of frames of sample images comprising the hand object within the second preset duration to obtain a trained command fusion module.

In a third aspect, one or more embodiments of the present disclosure provide an electronic device, including a processor and a memory which is in communication connection with the processor;
the memory is configured to store computer-executable instructions; and
the processor is configured to execute the computer-executable instructions stored in the memory to implement the method for recognizing a gesture according to the above-mentioned first aspect or various possible embodiments of the first aspect.

In a fourth aspect, one or more embodiments of the present disclosure provide a non-transitory computer-readable storage medium, which stores computer-executable instructions, and a processor, when executing the computer-executable instructions, implements a method for recognizing the gesture according to the above-mentioned first aspect or various possible embodiments of the first aspect.

In a fifth aspect, one or more embodiments of the present disclosure provide a computer program product, which includes a computer program, and the computer program, when executed by a processor, implements the method for recognizing a gesture according to the above-mentioned first aspect or various possible embodiments of the first aspect.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A method for recognizing a gesture, wherein the gesture comprises pose information and gesture command information, and the method comprises:
acquiring a plurality of frames of images comprising a hand object within a first preset duration before a current time;
respectively performing feature extraction on the plurality of frames of images to obtain a feature vector corresponding to each of the plurality of frames of images;
for a current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and
determining gesture command information corresponding to the hand object according to the feature vector corresponding to each of the plurality of frames of images and the preset deep learning model.

2. The method according to claim 1, wherein the respectively performing feature extraction on the plurality of frames of images to obtain the feature vector corresponding to each of the plurality of frames of images, comprises:
respectively performing feature extraction on the plurality of frames of images according to an image feature extraction model, to obtain the feature vector corresponding to each of the plurality of frames of images.

3. The method according to claim 1, wherein the preset deep learning model comprises a pose fusion module; and
the determining the pose information corresponding to the hand object according to the feature vector corresponding to the current frame of image, the feature vector corresponding to each of the at least one frame of target image and the preset deep learning model, comprises:
determining the pose information corresponding to the hand object according to the feature vector corresponding to the current frame of image, the feature vector corresponding to each of the at least one frame of target image and the pose fusion module,
wherein the pose information comprises coordinate information of a plurality of key points corresponding to the hand object, and rotation angle information of each key point among the plurality of key points.

4. The method according to claim 3, wherein the preset deep learning model further comprises a command fusion module; and
the determining the gesture command information corresponding to the hand object according to the feature vector corresponding to each of the plurality of frames of images and the preset deep learning model, comprises:
determining the gesture command information corresponding to the hand object according to the feature vector corresponding to each of the plurality of frames of images and the command fusion module,
wherein the gesture command information comprises a gesture command with an interactive function.

5. The method according to claim 1, wherein a total number of the plurality of frames of images is M, the current frame of image is an M-th frame of image, and M is a positive integer greater than 1; and
for the current frame of image, the determining at least one frame of target image before the current frame of image comprises:
for the current frame of image, determining that previous N frames of image before the current frame of image are target images, wherein N is a positive integer, and M is greater than N.

6. The method according to claim 1, wherein the preset deep learning model comprises a pose fusion module and a command fusion module; and
a training process of the preset deep learning model comprises:
a first stage: acquiring a plurality of frames of sample images comprising the hand object within a second preset duration, and for each sample image, training an initial pose fusion module by taking the sample image and at least one frame of target image before the sample image as training samples to obtain a trained pose fusion module; and
a second stage: training an initial command fusion module using the plurality of frames of sample images comprising the hand object within the second preset duration to obtain a trained command fusion module.

7. The method according to claim 2, wherein the preset deep learning model comprises a pose fusion module and a command fusion module; and
a training process of the preset deep learning model comprises:
a first stage: acquiring a plurality of frames of sample images comprising the hand object within a second preset duration, and for each sample image, training an initial pose fusion module by taking the sample image and at least one frame of target image before the sample image as training samples to obtain a trained pose fusion module; and
a second stage: training an initial command fusion module using the plurality of frames of sample images comprising the hand object within the second preset duration to obtain a trained command fusion module.

8. The method according to claim 3, wherein the preset deep learning model further comprises a command fusion module; and
a training process of the preset deep learning model comprises:
a first stage: acquiring a plurality of frames of sample images comprising the hand object within a second preset duration, and for each sample image, training an initial pose fusion module by taking the sample image and at least one frame of target image before the sample image as training samples to obtain a trained pose fusion module; and
a second stage: training an initial command fusion module using the plurality of frames of sample images comprising the hand object within the second preset duration to obtain a trained command fusion module.

9. The method according to claim 4, wherein a training process of the preset deep learning model comprises:
a first stage: acquiring a plurality of frames of sample images comprising the hand object within a second preset duration, and for each sample image, training an initial pose fusion module by taking the sample image and at least one frame of target image before the sample image as training samples to obtain a trained pose fusion module; and
a second stage: training an initial command fusion module using the plurality of frames of sample images comprising the hand object within the second preset duration to obtain a trained command fusion module.

10. The method according to claim 5, wherein the preset deep learning model comprises a pose fusion module and a command fusion module; and
a training process of the preset deep learning model comprises:
a first stage: acquiring a plurality of frames of sample images comprising the hand object within a second preset duration, and for each sample image, training an initial pose fusion module by taking the sample image and at least one frame of target image before the sample image as training samples to obtain a trained pose fusion module; and
a second stage: training an initial command fusion module using the plurality of frames of sample images comprising the hand object within the second preset duration to obtain a trained command fusion module.

11. An electronic device, comprising a processor and a memory which is in communication connection with the processor,
wherein the memory is configured to store computer-executable instructions; and
the processor is configured to execute the computer-executable instructions stored in the memory to implement a method for recognizing a gesture, wherein the gesture comprises pose information and gesture command information, and the method comprises:
acquiring a plurality of frames of images comprising a hand object within a first preset duration before a current time;
respectively performing feature extraction on the plurality of frames of images to obtain a feature vector corresponding to each of the plurality of frames of images;
for a current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and
determining gesture command information corresponding to the hand object according to the feature vector corresponding to each of the plurality of frames of images and the preset deep learning model.

12. The electronic device according to claim 11, wherein the respectively performing feature extraction on the plurality of frames of images to obtain the feature vector corresponding to each of the plurality of frames of images, comprises:
respectively performing feature extraction on the plurality of frames of images according to an image feature extraction model, to obtain the feature vector corresponding to each of the plurality of frames of images.

13. The electronic device according to claim 11, wherein the preset deep learning model comprises a pose fusion module; and
the determining the pose information corresponding to the hand object according to the feature vector corresponding to the current frame of image, the feature vector corresponding to each of the at least one frame of target image and the preset deep learning model, comprises:
determining the pose information corresponding to the hand object according to the feature vector corresponding to the current frame of image, the feature vector corresponding to each of the at least one frame of target image and the pose fusion module,
wherein the pose information comprises coordinate information of a plurality of key points corresponding to the hand object, and rotation angle information of each key point among the plurality of key points.

14. The electronic device according to claim 13, wherein the preset deep learning model further comprises a command fusion module; and
the determining the gesture command information corresponding to the hand object according to the feature vector corresponding to each of the plurality of frames of images and the preset deep learning model, comprises:
determining the gesture command information corresponding to the hand object according to the feature vector corresponding to each of the plurality of frames of images and the command fusion module,
wherein the gesture command information comprises a gesture command with an interactive function.

15. The electronic device according to claim 11, wherein a total number of the plurality of frames of images is M, the current frame of image is an M-th frame of image, and M is a positive integer greater than 1; and
for the current frame of image, the determining at least one frame of target image before the current frame of image comprises:
for the current frame of image, determining that previous N frames of image before the current frame of image are target images, wherein N is a positive integer, and M is greater than N.

16. The electronic device according to claim 11, wherein the preset deep learning model comprises a pose fusion module and a command fusion module; and
a training process of the preset deep learning model comprises:
a first stage: acquiring a plurality of frames of sample images comprising the hand object within a second preset duration, and for each sample image, training an initial pose fusion module by taking the sample image and at least one frame of target image before the sample image as training samples to obtain a trained pose fusion module; and
a second stage: training an initial command fusion module using the plurality of frames of sample images comprising the hand object within the second preset duration to obtain a trained command fusion module.

17. A non-transitory computer-readable storage medium, storing computer-executable instructions, wherein a processor, when executing the computer-executable instructions, implements a method for recognizing a gesture, wherein the gesture comprises pose information and gesture command information, and the method comprises:
acquiring a plurality of frames of images comprising a hand object within a first preset duration before a current time;
respectively performing feature extraction on the plurality of frames of images to obtain a feature vector corresponding to each of the plurality of frames of images;
for a current frame of image, determining at least one frame of target image before the current frame of image, and determining pose information corresponding to the hand object according to a feature vector corresponding to the current frame of image, a feature vector corresponding to each of the at least one frame of target image and a preset deep learning model; and
determining gesture command information corresponding to the hand object according to the feature vector corresponding to each of the plurality of frames of images and the preset deep learning model.

18. The storage medium according to claim 17, wherein the respectively performing feature extraction on the plurality of frames of images to obtain the feature vector corresponding to each of the plurality of frames of images, comprises:
respectively performing feature extraction on the plurality of frames of images according to an image feature extraction model, to obtain the feature vector corresponding to each of the plurality of frames of images.

19. The storage medium according to claim 17, wherein the preset deep learning model comprises a pose fusion module; and
the determining the pose information corresponding to the hand object according to the feature vector corresponding to the current frame of image, the feature vector corresponding to each of the at least one frame of target image and the preset deep learning model, comprises:
determining the pose information corresponding to the hand object according to the feature vector corresponding to the current frame of image, the feature vector corresponding to each of the at least one frame of target image and the pose fusion module,
wherein the pose information comprises coordinate information of a plurality of key points corresponding to the hand object, and rotation angle information of each key point among the plurality of key points.

20. The storage medium according to claim 19, wherein the preset deep learning model further comprises a command fusion module; and
the determining the gesture command information corresponding to the hand object according to the feature vector corresponding to each of the plurality of frames of images and the preset deep learning model, comprises:
determining the gesture command information corresponding to the hand object according to the feature vector corresponding to each of the plurality of frames of images and the command fusion module,
wherein the gesture command information comprises a gesture command with an interactive function.
